(19) United States
(12) Patent Application Publication
(10) Pub. No.: US 2003/0141095 A1
(43) Pub. Date: Jul. 31, 2003

(54) Cable splice closure

(76) Inventors: Dirk Roosen, Tienen (BE); Els Timmermans, Wilsele (BE); Dirk Deroost, Baal-Tremelo (BE)

Correspondence Address: Marguerite E Gerstner, Tyco Electronics Corporation, Intellectual Property Law Department, 307 Constitution Drive MS R20 2B, Menlo Park, CA, 94025-1164, US

(21) Appl. No.: 10/258,083

(22) PCT Filed: Mar. 29, 2001
(86) PCT No.: PCT/GB01/01369

(30) Foreign Application Priority Data
Apr. 8, 2000 (GB) 0008616.5

(51) Int. Cl. H01R 4/00; H02G 15/08

(52) U.S. Cl. 174/84 R

(57) ABSTRACT

A reinforcement member (1) for a cable splice is stiff yet resilient so as to attain a position of rest in which it has a substantially C-shaped cross-section leaving a longitudinal opening (2). Two such reinforcement members can be bent around the splice such that one reinforcement member closes off the opening of the other reinforcement member, thus completely surrounding the cable splice.

The present invention relates to a closure, in particular a soft-walled cable splice closure.

Several types of cable splice closures are known. A first type of closure has a hard casing as disclosed in, for example, EP 0 937 326. The hard walls of the casing provide mechanical protection of the cable splice. In addition, the hard casing provides support for axial pull relief members as disclosed in, for example, EP 0 782 778. A second type of cable splice closure does not have a hard casing, being made up of a tape or sheet which is wound around the cable splice. An example of such a closure is disclosed in, for example, EP 0 880 212. Such soft-walled closures are generally easy to adapt to various splice dimensions. However, they lack the rigidity to provide axial pull relief In addition, the degree of mechanical protection provided by these soft-walled closures is necessarily limited.

It is noted that in soft-walled closures often a so-called liner is used. A liner is a flexible sheet which is wrapped around the cable splice to provide a smooth shape which is convenient for the subsequent wrapping of the tape or sheet constituting the outer wall of the closure. In addition to this shaping function, a liner provides a limited degree of mechanical protection. Often liners are made of cardboard A composite liner having folding lines to facilitate wrapping around a cable splice is disclosed in European Patent EP 0 025 691 (Raychem). This liner also has little structural rigidity and merely serves to shape the splice and to provide a vapour barrier.

It is therefore an object of the present invention to mitigate the disadvantages of the Prior Art and to provide a cable closure which can easily be adapted to various cable splice diameters yet has sufficient mechanical rigidity to provide mechanical protection and/or axial pull relief

It is another object of the present invention to provide a reinforcement member for reinforcing cable splice closures, in particular soft-walled cable splice closures.

It is yet another object of the present invention to provide a reinforcement member for a cable splice closure which can be easily applied without the need for any fasteners.

It is a further object of the present invention to provide a reinforcement member for a cable splice closure which does not have to be cut to the required diameter.

It is yet a further object of the present invention to provide a kit-of-parts for forming cable splice closures having sufficient mechanical rigidity to provide mechanical protection and/or axial pull relief.

It is a still further object of the present invention to provide a simple and economical method of forming a closure around a cable splice, having sufficient mechanical rigidity to provide mechanical protection and/or axial pull relief.

Accordingly, the present invention provides a reinforcement member for a cable splice which is characterised by being stiff yet resilient so as to attain a position of rest in which it has a substantially C-shaped cross-section leaving a longitudinal opening.

By providing a substantially C-shaped cross section when not bent by external forces, sufficient resilience for the “C” to be bent open by an operator and to veer back into its original shape when released, and sufficient stiffness to remain in its position around the cable splice, the reinforcement member of the present invention can be installed very easily. That is, the reinforcement member is bent open, placed around the cable splice and is then allowed to “snap” back into its original form (to the extent the dimensions of the cable splice allow). Installation of the reinforcement member is thus much facilitated as no tape or other fastening means is required to keep the reinforcement member in place, the resilience of the reinforcement member generally providing sufficient pressure on the cable splice for the member to stay in place.

Another advantage of the reinforcement member of the present invention is that it can have a very simple shape and is therefore inexpensive to manufacture.

Yet another advantage of the reinforcement member of the present invention is that there is no need to cut it to size to fit the diameter of the cable splice. That is, the reinforcement member will normally not cover the entire circumference of the cable splice, leaving a gap which can easily be bridged by applying a second reinforcement member, as will later be explained in more detail. The overlap only provides additional mechanical protection and will, due to the stiff Yet resilient nature of the reinforcement member, naturally follow the circumference of the cable splice when applied on a cable splice having a diameter greater than the original diameter of the member There is, therefore, no need to fasten or remove the overlapping portions.

The gap or opening between the longitudinal edges of the reinforcement member must be wide enough to accommodate a cable splice (so as to allow a “wrap-around” installation of the reinforcement member) yet not so wide that the reinforcement member will fall off. That is, some (if very little) bending by the operator must be required to apply the reinforcement member. Accordingly, the opening spans an angle of less than 180°. Conversely, the reinforcement member spans a circumferential angle of at least 180°, preferably at least 240° to allow the member to stay in place without applying external means. In order to provide a secure fit without having to bend the reinforcement member too far, the opening advantageously spans an angle of more than 60° and less than 120°. It will be understood that the actual span of the gap may depend on the material properties of the reinforcement member, its thickness, and possibly also on the relative size of the cable splice.

The material of the reinforcement member is preferably polyethylene, but various plastics may also be used provided they have a suitable stiffness and resilience. Metal reinforcement members may also be used. Reinforced cardboard can also be employed, the reinforcements for example consisting of plastic or metal strips extending in the circumferential and/or longitudinal direction of the reinforcement member.

In order to provide a smooth transition from the cable splice diameter to the cable diameter, the reinforcement member is advantageously provided with longitudinally extending flexible fingers. Preferably, at least some of the fingers have a widened end portion to provide an axial pull knob. Ever, third finger, for example, maybe widened for this purpose. The widened end portion preferably is substantially rectangular, but triangular end portions (“arrow tips”) may also be envisaged. The axial pull knob may be engaged by a ring or the like which is tightened around the cables emerging from the member.

The present invention also provides a kit-of-parts for forming a cable splice closure, comprising two reinforcement members according to the present invention.

Advantageously, the kit-of-parts further comprises tape for taping around the reinforcement members.

The present invention further provides a method of forming a closure around a cable splice, the method comprising the steps of providing a first and second reinforcement member as defined above, bending the first and second reinforcement members around the cable splice in such a way that the opening of the first reinforcement member is closed off by the second reinforcement member, and applying an encapsulating surface around at least the end parts of the reinforcement members. This method is very, simple and can easily be carried out by a single operator. Preferably the encapsulating surface is provided by a length of tape which is wound around the reinforcement member.

The present invention is based on the insight that the advantageous properties of both hard-walled closures and soft-walled closures can be combined by providing soft-walled closures with a rigid reinforcement member.

The invention will now be further illustrated by way of exemplary embodiments shown in the accompanying drawings in which:

FIG. 1 shows, in perspective, a reinforcement member according to the present invention.

FIG. 2 shows, in plan view, the reinforcement member of FIG. 1.

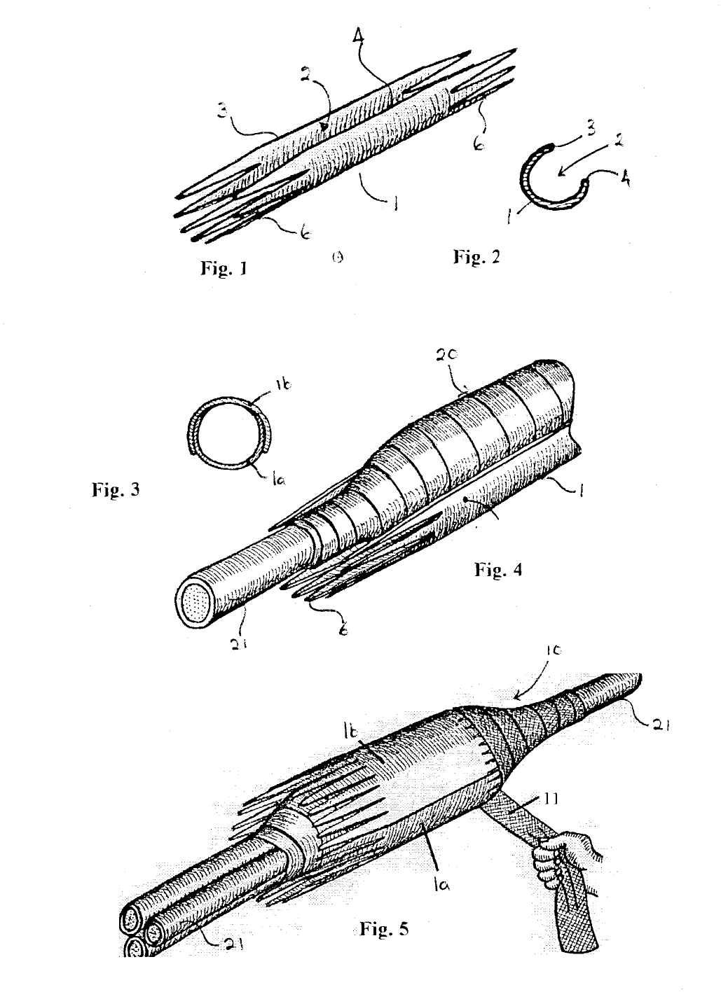

FIG. 3 shows, in plan view, a combination of two reinforcement members of FIG. 1.

FIG. 4 shows, in perspective, a reinforcement member according to the present invention being applied on a cable splice.

FIG. 5 shows, in perspective, how a cable closure is made in situ using reinforcement members according to the present invention.

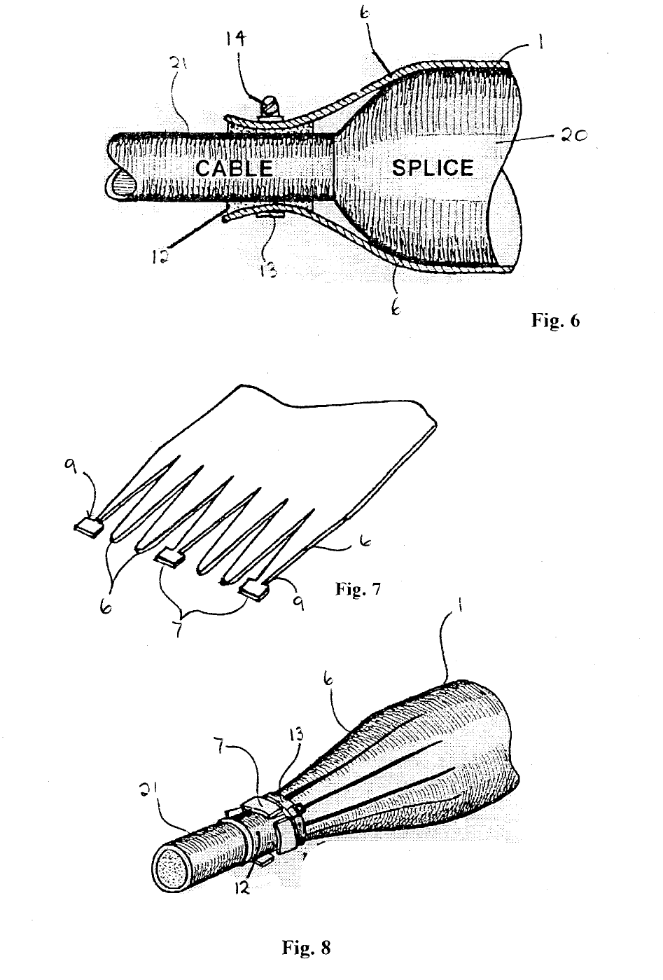

FIG. 6 shows, in partial cross-section, a reinforcement member according to the present invention as applied on a cable splice.

FIG. 7 shows, in perspective, part of an alternative embodiment of a reinforcement member according to the present invention having axial pull knobs.

FIG. 8 shows, in perspective, the arrangement of FIG. 6 using the member shown in FIG. 7.

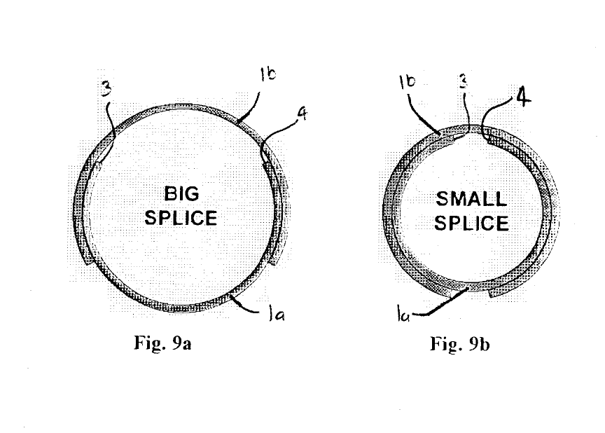

FIGS. 9a and 9b show, in cross-section, how a set of two reinforcement members according to the present invention can be used to accommodate cable splices of various dimensions.

The cable splice reinforcement member 1 shown in FIG. 1 has a substantially “C”-shaped cross-section, as illustrated in FIG. 2. The two longitudinal edges 3 and 4 leave an opening 2 which extends over the entire length of the reinforcement member 1 and which allows a cable splice (not shown) to pass into the interior of the reinforcement member. As shown in FIG. 2, the opening 2 between the edges 3 and 4 spans, in the depicted rest state of the reinforcement member, an angle of approximately 90°. The resilient properties of the reinforcement member allow it to be bent open to place it around a cable splice and to automatically close upon being released. Once applied, it is sufficiently stiff to maintain its position around the cable splice. The span angle of the opening 2 is chosen so as to allow an easy installation of the reinforcement member while providing a secure fit once installed, preventing the reinforcement member from coming off the splice when not being handled by the operator.

As shown in FIG. 3, the gap left by the openings 2 after installation can easily be closed off by applying a second reinforcement member 1b covering the opening 2 of the first reinforcement member 1a. Preferably, the second reinforcement member 1b is identical to the first reinforcement member 1a. If the members are identical, a slight deformation is required to make them overlap. This deformation results in a resilience force which maintains their relative positions. The overlapping parts of the two reinforcement members provide additional mechanical protection.

The reinforcement member 1 of FIG. 1 is provided with flexible fingers 6 which extend in the reinforcement member's longitudinal direction. As will be explained later with reference to FIG. 6, these fingers 6 serve to provide a smooth transition from the cable to the splice. It will be understood, however, that the fingers are an optional feature and that a reinforcement member according to the present invention may have no fingers at all, resulting in substantially smooth front and back edges.

Referring now to FIG. 4, a so-called filled cable splice 20 is shown to be pre-taped. The splice may be provided with a liner and may subsequently be filled (e.g. with polyurethane) and taped. A cable section 21 emerges from the taped area. Although pre-taping is often desirable to enclose and protect the cable splice. It is by no means essential. A reinforcement member according to the present invention is bent open so as to accommodate the cable splice 20.

As shown in FIG. 5 a pair of reinforcement members 1a, 1b may be used to completely surround the cable splice (cf. FIG. 3). Tape 11 is then applied to completely immobilise the reinforcement members 1a and 1b and to shape the fingers 6 so as to provide a smooth transition region. The tape 11 preferably is an elastic, adhesive tape which is tightly wound around the reinforcement members. Although normally tape will be applied along the entire length of the reinforcement members, it is possible to only cover the fingers 6, leaving the middle part exposed.

Prior to applying the tape 11 a clamp 13 may be applied to hold down the fingers 6. A rubber strip 12 may previously be wound around the cable 21 to provide resilience, as will later be explained with reference to FIG. 8. This arrangement provides axial pull relief as any axial pull forces will be taken up by the reinforcement member 1 instead of by the splice 20.

The reinforcement member 1 of FIG. 7, which is shown flattened for the sake of clarity only, has flexible fingers 6 some of which are provided with substantially rectangular end pieces 7. These end pieces 7 serve as axial pull relief knobs which can be engaged by suitable engaging means, such as a clamp 13, as shown in FIG. 8.

The arrangement shown in FIG. 8 corresponds to that of FIG. 6 but more clearly shows the axial pull knobs 7 of FIG. 7. The clamp or ring 13 is tightened around the cable 21, pressing down the fingers 6. The rubber strip 12 (cf FIG. 6) allows the fingers 6 to be resiliently held With copper cables, it is possible to tighten the clamp 13 to the extent of deforming the cable surface in order to obtain an even better engagement of the fingers 6. It is noted that in the embodiment shown, the clamp 13 is provided with a tightening screw 14. Such a clamp is known in the Art.

The (optional) axial pull knobs 7 are less curved than the rubber strip 12 and their engagement surfaces 9 (FIG. 7) will be engaged by the clamp 13, providing an excellent axial pull relief.

The reinforcement members of the present invention can be used for splices of various sizes, as shown in FIGS. 9a and 9b. When enclosing a relatively big cable splice, the opening between the edges 3 and 4 is relatively large, as shown in FIG. 9a. Consequently, there is relatively little overlap between the reinforcement members 1a and 1b.

When accommodating a relatively small cable splice, however, the opening between the edges 3 and 4 is relatively small, as shown in FIG. 9b. In the latter case there is relatively much overlap between the reinforcement members 1a and 1b.

As shown in FIG. 9, it is possible to accommodate a large variety of splice diameters by using only a few different reinforcement member sizes. It is preferred to use members having a (slightly) smaller inner diameter than the cable splice they are applied on. This will cause the resilience of the member to keep it in place. It is, however, also possible to use members having a larger inner diameter than the cable splice they are applied on. In that case it may be necessary to use additional means for tightening the member(s) around the cable splice.

It will be understood by those skilled in the art that the present invention is not limited to the embodiments shown and that many additions and modifications are possible without departing from the scope of the present invention as defined in the appending claims.

1. Reinforcement member (1) for a cable splice (20), characterised by being stiff yet resilient so as to attain a position of rest in which it has a substantially C-shaped cross-section leaving a longitudinal opening (2).

2. Reinforcement member according to claim 1, wherein the opening (2) spans an angle of less than 180°.

3. Reinforcement member according to claim 1, wherein the opening (2) spans an angle of more than 60° and less than 120°.

4. Reinforcement member according to any of the preceding claims, comprising longitudinally extending flexible fingers (6).

5. Reinforcement member according to claim 4, wherein at least some of the fingers (6) have a widened end portion (7).

6. Kit-of-parts for forming a cable splice closure (10), comprising two reinforcement members (1) according to any of the preceding claims.

7. Kit-of-parts according to claim 6, further comprising tape (11) for taping around the reinforcement members (1).

8. Kit-of-parts according to claim 6 or 7, further comprising at least two strips (12) of sealing material and at least two clamps (13) for providing end seals.

9. Method of forming a closure (10) around a cable splice (20), the method comprising the steps of:
providing a first and second reinforcement member (1a, 1b) according to any of claims 1-5;
bending the first and second reinforcement members around the cable splice (20) in such a way that the opening (2) of the first reinforcement member (1a) is closed off by the second reinforcement member (1b), and
applying an encapsulating surface (15) around the reinforcement members (1a, 1b).

10. Method according lo claim 9, wherein the encapsulating surface (15) is provided by a length of tape.
